(19) United States
(12) Patent Application Publication
(10) Pub. No.: US 2020/0364643 A1
(43) Pub. Date: Nov. 19, 2020

(54) METHOD AND APPARATUS FOR DISTRIBUTED COLLABORATIVE RESOURCE ALLOCATION

(71) Applicant: ELECTRONICS AND TELECOMMUNICATIONS RESEARCH INSTITUTE, Daejeon (KR)

(72) Inventors: Heechul BAE, Daejeon (KR); Hyun Chul KANG, Daejeon (KR); Ji Yeon SON, Daejeon (KR); Eun Seo LEE, Daejeon (KR); Hyonyoung HAN, Daejeon (KR)

(21) Appl. No.: 16/872,550

(22) Filed: May 12, 2020

(30) Foreign Application Priority Data
May 13, 2019 (KR) 10-2019-0055448

(51) Int. Cl. G06Q 10/06; G06Q 50/04; G06N 5/04; G05B 13/02

(52) U.S. Cl. CPC G06Q 10/06315; G06Q 50/04; G05B 13/028; G06Q 10/0639; G06N 5/043; G06Q 10/06316

(57) ABSTRACT

The apparatus for distributed collaborative resource allocation receives order information and job start information for each process from a factory agent, calculates a slack time of a job used as an evaluation indicator for an order through the order information and job start information for each process, determines participation in a job on the order using the evaluation indicator of each machine agent, sets a machine agent having the highest evaluation indicator among machine agents for each process representing the participation as a negotiating agent for a corresponding process, and proceeds with negotiation for production quantity with the remaining machine agents representing the participation in the corresponding process.

### CROSS-REFERENCE TO RELATED APPLICATION

This application claims priority to and the benefit of Korean Patent Application No. 10-2019-0055448 filed in the Korean Intellectual Property Office on May 13, 2019, the entire contents of which are incorporated herein by reference.

### BACKGROUND OF THE INVENTION

### 1. Field of the Invention

The present invention relates to a method and apparatus for distributed collaborative resource allocation. In particular, the present invention relates to a method and apparatus for distributed collaborative resource allocation to allocate and manage machine resources to be suitable for personalized manufacturing, such as quantity batch production, through distributed collaboration among machines.

### 2. Description of Related Art

In the case of production planning establishment by allocating machine resources in a manufacturing factory, monthly, weekly, and daily production quantity and production orders are determined through production planning and scheduling based on demand forecasting for products. Such production planning establishment is to plan the capacity of the resources ahead based on the demand forecasting, and to determine and execute an efficient production order that satisfies the planned production quantity in the period by a center.

In the case of such a centralized plan, if a difference between the forecasted demand and the actual demand is large, or if a problem or fluctuation of machine resources has occurred, the changes and disruptions occur in the established production plan and rapid response becomes difficult. Therefore, most factories handle unexpected fluctuations by having sufficient buffer or capacity when planning for resource allocation is established.

Furthermore, there are several difficulties in terms of time and cost efficiency of resource utilization and planning establishment to modify and change the plan each time in accordance with the dynamic situation of the work site from the center.

It is impossible to establish a plan considering all of the various fluctuation factors in a factory site due to such difficulties, and it takes a considerable amount of time to re-establish a definitive schedule for main resources, so rapid response to simultaneous variability is impossible. Thus, it is usual to plan ahead and control the planning through available capacity of resources and rapid response and management of the factory site. As described above, the resource allocation problem in the manufacturing environment is a decision problem with high uncertainty and variability.

### SUMMARY OF THE INVENTION

The present invention has been made in an effort to provide a method and apparatus for distributed collaborative resource allocation having advantages of efficiently utilizing machine resources in response to variability of the factory in the manufacturing site.

According to an exemplary embodiment of the present invention, a method for distributed collaborative resource allocation for allocating machine resources through distributed collaboration among machines is provided. The method for distributed collaborative resource allocation includes: receiving, by each machine agent for each process, order information and job start information for each process from a factory agent; calculating, for each machine agent for each process, slack time of a job used as an evaluation indicator for an order through the order information and job start information for each process; determining, for each machine agent for each process, participation for the order using the evaluation indicator, and setting a machine agent having the highest evaluation indicator among machine agents for each process representing the participation as a negotiating agent for a corresponding process; and proceeding with, by a negotiating agent of the corresponding process, negotiation for production quantity with the remaining machine agents representing the participation in the corresponding process.

The proceeding with the negotiation may include performing the negotiation for production quantity in a way in which all machine agents representing participation in the corresponding process have a gain from participation in the job.

The proceeding with the negotiation may include setting a production quantity of the negotiating agent as a first ratio and checking whether the gain from the participation of the negotiating agent in the job occurs, when the gain from the participation of the negotiating agent occurs, setting a production quantity of the remaining machine agents representing the participation as a second ratio based on the first ratio and checking whether the gain from the participation of the remaining machine agents in the job occurs, and adjusting the first ratio and the second ratio when not all of the remaining machine agents have the gain from participation in the job.

The second ratio may be determined based on the first ratio and the number of remaining machine agents

The adjusting of the first ratio and the second ratio may include reducing the first ratio by a set negotiation unit

The proceeding with the negotiation may further include setting the production quantity of the machine agents representing participation equally when there is no gain in the participation of the negotiating agent.

The determining of participation for the order may include setting, for each machine agent, a desired threshold value for a job of a machine, and determining, for each machine agent, participation for the order through a comparison between the evaluation indicator of each machine agent and the desired threshold value for the job of the machine of each machine agent.

The desired threshold value for the job of the machine may be set to be lower as a capacity utilization rate of the corresponding machine is lower.

The calculating of slack time of a job, the determining of participation for the order, the setting of a negotiating agent, and the proceeding with negotiation for production quantity may be performed sequentially for each process.

When the production quantity is determined through the negotiation in the previous process, job start information of the next process may be determined by the factory agent.

According to another embodiment of the present invention, an apparatus for distributed collaborative resource allocation for allocating machine resources through distributed collaboration among machines is provided. The apparatus for distributed collaborative resource allocation includes an interface and a processor. The interface sequentially receives process order information and job start information from a factory agent. The processor calculates an evaluation indicator for the order in a corresponding process based on the process order information and job start information in the corresponding process, determines participation of machine agents in the order using the evaluation indicator in the corresponding process, and determines production quantity through negotiation among machine agents representing the participation.

The processor may compare the evaluation indicators of machine agents representing the participation, and allows a machine agent with a highest evaluation indicator to act as a negotiating agent.

When the processor acts as the negotiating agent, the processor performs negotiations on the production quantity in a way in which all machine agents representing participation in the corresponding process have a gain from participation in the job.

When the processor acts as the negotiating agent, the processor may set a production quantity of the negotiating agent as a first ratio and checks whether the gain from the participation of the negotiating agent in the job occurs, may set a production quantity of the remaining machine agents representing the participation as a second ratio and checks whether the gain from the participation of the remaining machine agents in the job occurs when the gain from the participation of the negotiating agent occurs, and may adjust the first ratio and the second ratio when not all of the remaining machine agents have the gain from participation in the job.

The second ratio may be determined based on the first ratio and the number of remaining machine agents.

The processor may set the production quantity of the machine agents representing participation equally when there is no gain in the participation of the negotiating agent.

The processor may set a desired threshold value for a job of a machine, and determines that there is participation in the order when the evaluation indicator is equal to or higher than the desired threshold value for a job of a machine.

The evaluation indicator may include slack time of the job.

### BRIEF DESCRIPTION OF THE DRAWINGS

FIG. 1 is a diagram illustrating an entire configuration of an apparatus for distributed collaborative resource allocation according to an embodiment of the present invention.

FIG. 2 is a diagram illustrating a method for distributed collaborative resource allocation between a factory agent and machine agents.

FIG. 3 is a diagram illustrating a method for calculating an evaluation indicator according to an embodiment of the present invention.

FIG. 4 is a diagram illustrating a method for determining participation according to an embodiment of the present invention.

FIG. 5 is a diagram schematically illustrating a negotiation method of a negotiating agent according to an embodiment of the present invention.

FIG. 6 is a diagram illustrating a method for negotiating among machines for resource allocation on each order according to an embodiment of the present invention.

FIG. 7 is a diagram schematically illustrating an apparatus for distributed collaborative resource allocation according to an exemplary embodiment of the present invention.

### DETAILED DESCRIPTION OF THE EMBODIMENTS

Hereinafter, embodiments of the present invention will be described in detail with reference to the attached drawings so that a person of ordinary skill in the art may easily implement the present invention. The present invention may be modified in various ways, and is not limited thereto. In the drawings, elements that are irrelevant to the description of the present invention are omitted for clarity of explanation, and like reference numerals designate like elements throughout the specification.

Throughout the specification and claims, when a part is referred to “include” a certain element, it means that it may further include other elements rather than exclude other elements, unless specifically indicated otherwise.

Hereinafter, a method and apparatus for distributed collaborative resource allocation according to embodiments of the present invention will be described in detail with reference to the accompanying drawings.

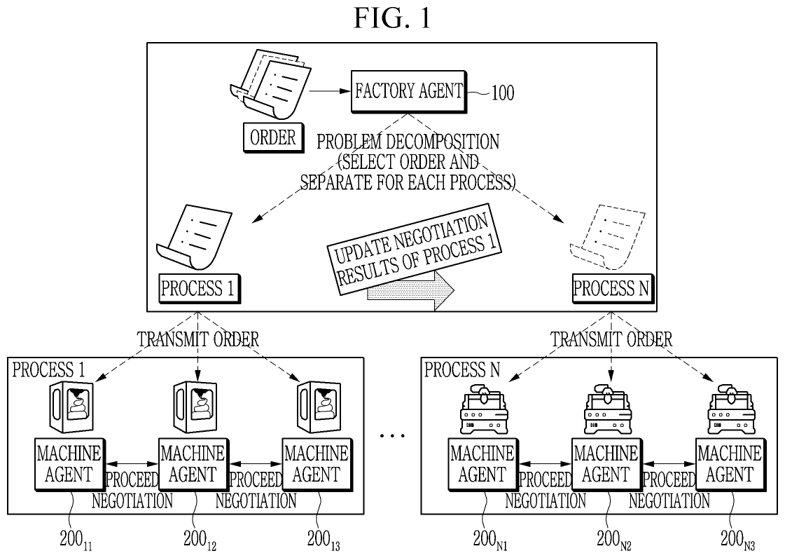

FIG. 1 is a diagram illustrating an entire configuration of an apparatus for distributed collaborative resource allocation according to an embodiment of the present invention.

Referring to FIG. 1, the apparatus for distributed collaborative resource allocation may include a factory agent 100 and a plurality of machine agents 200₁₁ to 200₁₃, 200₂₁ to 200₂₃, . . . , 200_{N1} to 200_{N3}.

The factory agent 100 determines the priority of job assignment for one or more orders by calculating the amount of spare time between orders based on time information such as the customer's order quantity, production time by each process, and due date of the customer.

The factory agent 100 separates and processes each process through problem decomposition for each order according to the priority of job assignment. The factory agent 100 sequentially transmits order information and job start time information to a machine agent for each process.

The plurality of machine agents 200₁₁ to 200₁₃, 200₂₁ to 200₂₃, . . . , 200_{N1} to 200_{N3} automate and intelligent machines to each production line, and the machines with corresponding machine agents have the function for selecting the job to be performed by themselves and executing the job. The plurality of machine agents 200₁₁ to 200₁₃, 200₂₁ to 200₂₃, . . . , 200_{N1} to 200_{N3} are grouped by process. For example, machine agents 200₁₁ to 200₁₃ are autonomous and intelligent machines installed in the production line of process 1, respectively, and machine agents 200_{N1} to 200_{N3} are autonomous and intelligent machines installed in the production line of process N, respectively. FIG. 1 shows the N-stage process and three machine agents that are included for each process. The number of machine agents for each process may be different from this, and the number of machine agents for each process may be different from each other.

The machine agents 200₁₁ to 200₁₃, 200₂₁ to 200₂₃, . . . , 200_{N1} to 200_{N3} determine the machine resources to participate in the order by process, and determine the production quantity of the machines to participate in the order through negotiation. In the case of negotiation among machine resources for each process, machine agents 200₁₁ to 200₁₃, 200₂₁ to 200₂₃, . . . , 200_{N1} to 200_{N3} proceed with negotiation in a way in which all machine agents representing participation have a gain from participation in the job by calculating the gain on participation in the job for each machine and the opportunity cost on non-participation in the job for each machine. When the negotiation for each process is completed and the production quantity of participating machines in the job are determined, the machine agents 200₁₁ to 200₁₃, 200₂₁ to 200₂₃, . . . , 200_{N1} to 200_{N3} transmit the negotiation results to the factory agent 100.

When the production quantity of participating machines in the job for each process is determined by the machine agents 200₁₁ to 200₁₃, 200₂₁ to 200₂₃, . . . , 200_{N1} to 200_{N3} for each process, the factory agent 100 updates the production schedule result for each process.

The separating and processing for each process through problem decomposition is now described in detail. It is assumed that one product sequentially completes process 1, process 2, and process 3 for one order, the factory agent 100 transmits order information and job start information for process 1 to the machine agents 200₁₁ to 200₁₃ of process 1, and the machine agents 200₁₁ to 200₁₃ proceed with negotiation based on the order information, and transmit the negotiation results to the factory agent 100. When the factory agent 100 receives the negotiation result of process 1, the factory agent 100 determines job start information for process 2 corresponding to the next process, and transmits order information and job start information for process 2 to the machine agents 200₂₁ to 200₂₃ of process 2. When the machine agents 200₂ to 200₂₃ receive order information and job start information, they proceed with negotiation based on the order information, and transmit the negotiation results to the factory agent 100. When the factory agent 100 receives the negotiation result of process 2, the factory agent 100 determines job start information for process 3 corresponding to the next process, and transmits order information and job start information for process 3 to the machine agents 200₃₁ to 200₃₃ of process 3. When the machine agents 200₃₁ to 200₃₃ receive the order information and the job start information, they proceed with negotiation based on the order information, and transmit the negotiation results to the factory agent 100.

As described above, according to the apparatus for distributed collaborative resource allocation according to the embodiment of the present invention, the factory agent 100 determines the flexible job priority for the order from the customer, separates the problem for each process, and allows the production quantity to be determined through the negotiation for each process. Then, the machine agents 200₁₁ to 200₁₃, 200₂₁ to 200₂₃, . . . , 200_{N1} to 200_{N3} determine production quantity through the negotiation among machine resources for each process.

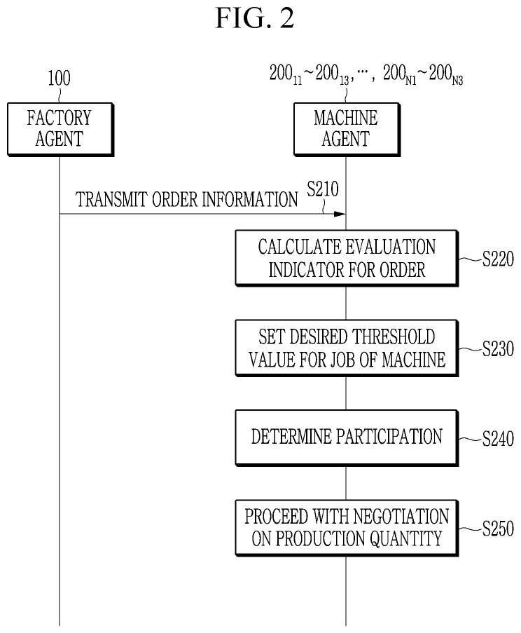

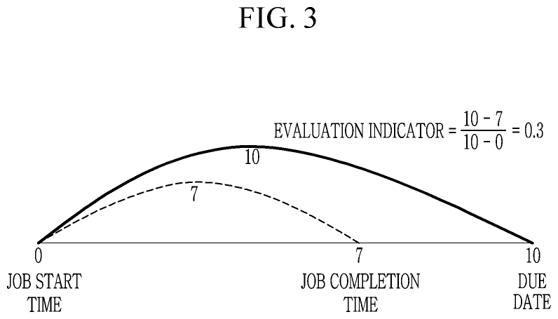

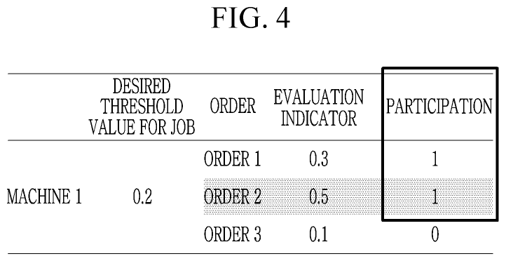

FIG. 2 is a diagram illustrating a method for distributed collaborative resource allocation between a factory agent and machine agents, and FIG. 3 is a diagram illustrating a method for calculating an evaluation indicator according to an embodiment of the present invention. Furthermore, FIG. 4 is a diagram illustrating a method for determining participation according to an embodiment of the present invention.

Referring to FIG. 2, the factory agent 100 sequentially transmits order information and job start information to machine agents 200₁₁ to 200₁₃, 200₂₁ to 200₂₃, . . . , 200_{N1} to 200_{N3} for each process through problem decomposition on orders from customers (S210). When the negotiation is completed by the machine agents of the previous process, the factory agent 100 may transmit order information and job start information to the machine agents of the next process.

When multiple orders occur at the same time, the factory agent 100 may determine the priority of job assignment for the multiple orders so that an order having a small slack time of the job available time at the present time is allocated first, utilizing the due date, order quantity, production time, etc.

When the machine agents 200₁₁ to 200₁₃, 200₂₁ to 200₂₃, . . . , 200_{N1} to 200_{N3} receive order information and job start information, they calculate an evaluation indicator for the order, respectively (S220). The machine agents 200₁₁ to 200₁₃, 200₂₁ to 200₂₃, . . . , 200_{N1} to 200_{N3} may calculate the slack time of the job as an evaluation indicator. The slack time of the job may be calculated using the job start time, job completion time, and due date. The calculated slack time of the job may be a value between 0 and 1.

For example, the evaluation indicator may be calculated as in Equation 1.

$$Evaluation indicator ( slack time ) = \frac{due date - job completion time}{due date - job start time} \qquad ( Equation 1 )$$

For example, it is assumed that the due date, a job start time, and a job completion time for a certain machine are given as shown in FIG. 3. In this case, the evaluation indicator of the machine agent is 0.3.

The machine agents 200₁₁ to 200₁₃, 200₂₁ to 200₂₃, . . . , 200_{N1} to 200_{N3} set a desired threshold value for a job of a machine, respectively (S230). The machine agents 200₁₁ to 200₁₃, 200₂₁ to 200₂₃, . . . , 200_{N1} to 200_{N3} are set so that the desired threshold value for a job of a corresponding machine is set to be lower as a capacity utilization rate of a machine is lower among machines capable of performing the same process.

The machine agents 200₁₁ to 200₁₃, 200₂₁ to 200₂₃, . . . , 200_{N1} to 200_{N3} determine the participation of the corresponding machine for the order (S240). The machine agents 200₁₁ to 200₁₃, 200₂₁ to 200₂₃, . . . , 200_{N1} to 200_{N3} may determine the participation of the corresponding machine by comparing the desired threshold value with the evaluation indicator of the corresponding machine for the order as shown in Equation 2. The machine agents 200₁₁ to 200₁₃, 200₂₁ to 200₂₃, . . . , 200_{N1} to 200_{N3} may determine to participate with the corresponding machine in the job on the order when the evaluation indicator is above the desired threshold value for a job, and may determine not to participate with the corresponding machine in the job on the order when the evaluation indicator is below the desired threshold value for job.

$$Participation = \{ \begin{matrix}1 , evaluation indicator \geq desired threshold value for job \\ 0 , evaluation indicator < desired threshold value for job\end{matrix} \} \qquad ( Equation 2 )$$

For example, as referred in FIG. 4, it is assumed that the desired threshold value for the job of machine 1 is 0.2, and the evaluation indicators are 0.3, 0.5, and 0.1 for order 1, order 2, and order 3, respectively. In this case, the equipment machine agent of machine 1 may determine to participate in the job on orders 1 and 2, and may determine not to participate in the job on order 3.

Next, the machine agents representing the participation in the job for the corresponding order proceed with negotiation on the production quantity (S250). At this time, a machine agent having the highest evaluation indicator (slack time) among machines capable of performing the same process for the same order acts as a negotiating agent. The negotiating agent negotiates among the machines representing the participation in the job for the corresponding order to determine the production quantity.

Steps S210 to S250 are repeated until all orders are allocated.

As described above, machine agents for each process 200₁₁ to 200₁₃, 200₂₁ to 200₂₃, . . . , 200_{N1} to 200_{N3} sequentially receive order information and job start information from the factory agent 100, so steps S210 to S250 are also performed sequentially for each process.

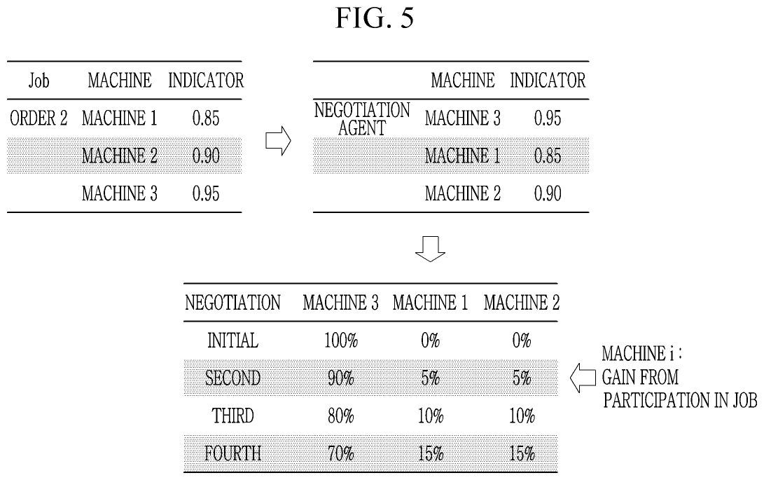

FIG. 5 is a diagram schematically illustrating a negotiation method of a negotiating agent according to an embodiment of the present invention.

Referring to FIG. 5, a machine agent having the highest evaluation indicator among machines capable of performing the same process for the same order becomes a negotiating agent. For example, it is assumed that the participating machines for order 2 are machine 1, machine 2, and machine 3, and the evaluation indicators for machines 1, 2, and 3 are 0.85, 0.90, and 0.95, respectively. In this case, the machine 3 with the highest evaluation index becomes the negotiating agent.

The negotiating agent sets the production quantity of the negotiating agent to 100%, sets the production quantity of other machines representing participation in the order to 0%, and then checks whether gain of each machine from the participation in the job occurs. The negotiating agent may check whether the gain of each machine occurs based on a loss when each machine participates in the job and a loss when each machine does not participate in the job. The negotiating agent reduces the production quantity of the negotiating agent by a predetermined negotiation unit, and then proceeds with negotiation again when not all machines representing participation in the job of the order have a gain from participation in the job. In other words, the negotiating agent negotiates in a way that all machines have a gain from the participation in the job.

For example, when the machine 3 with the highest evaluation indicator becomes the negotiating agent, the negotiating agent sets the production quantity of the machine 3 to 100%, and the production quantity of the machine 1 and the machine 2 representing the participation in the job on the order 2 to 0%, respectively. Then, the negotiating agent checks whether the gains to the participation of the machines 1, 2, and 3 occur. The negotiating agent determines that the negotiation has been achieved when the gains from participation in the job of all machines occur, and terminates the negotiation procedure.

Meanwhile, the negotiating agent reduces the production quantity of the machine 3 by the predetermined negotiation unit (for example, 10%), and allocates the machine 1 and the machine 2 by dividing the reduced production quantity into the machine 1 and the machine 2 when not all machines representing participation in the job on the order 2 have a gain from participation in the job. Then, the negotiating agent proceeds with negotiation as described above.

As described above, the negotiating agent negotiates in a way that all machines have a gain from participation in the job.

In this way, when the negotiation procedure is completed, the production quantity of the each machine representing the participation in the job on the order is determined.

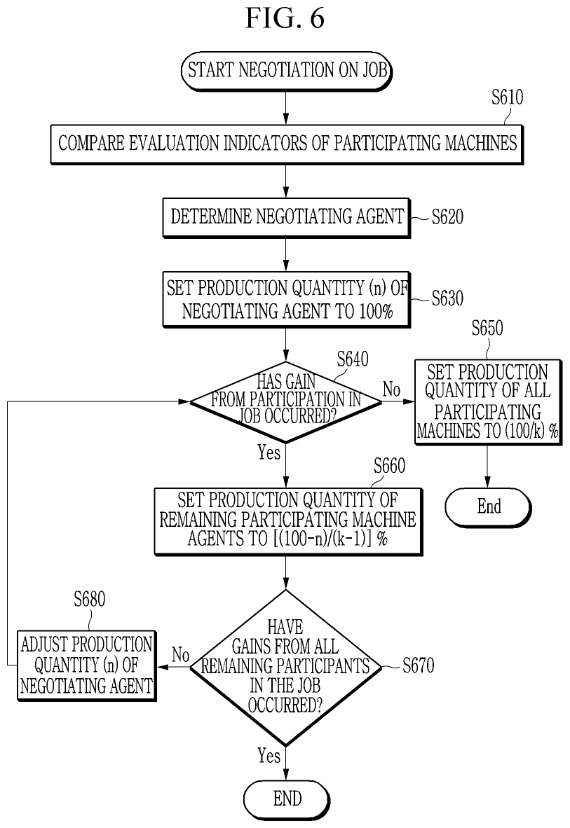

FIG. 6 is a diagram illustrating a method for negotiating among machines for resource allocation on each order according to an embodiment of the present invention.

Referring to FIG. 6, when negotiation on the job is started for each order, the machine agents of the participating machines representing the participation on each order compare the evaluation indicators with each other to determine the negotiating agent for each order (S610, S620). For convenience of description, it is assumed that the number of participating machines on the order is k in FIG. 6.

When the negotiating agent on the order is determined, the negotiating agent sets the production quantity (n) of the own machine to 100% (S630), and checks whether the gain from participation in the job of the own machine occurs (S640). At this time, n represents the production quantity of the machine of the negotiating agent.

The negotiating agent sets the production quantity of the participating machines representing participation on the corresponding order equally to 100/k (%) if the gain from participation in the job does not occur when the production quantity of the own machine of the negotiating agent is set to 100% (S650).

On the other hand, if the gain from participation in the job does not occur when the production quantity of the own machine of the negotiating agent is set to 100%, the negotiating agent sets the production quantity of the remaining participating machines to [(100−n)/(k−1)]% (S660), and calculates gains from participation in the job of remaining participating machines, and then checks whether gains from participation in the job of remaining participating machines occur (S670).

When not all of the remaining participating machines have a gain from participation in the job, the negotiating agent adjusts the production quantity (n) of the negotiating agent by a predetermined negotiation unit (S680). That is, the negotiating agent reduces the production quantity of its own machine by the predetermined negotiating unit, and then repeats steps S630 to S670.

The negotiating agent terminates the negotiation when all of the remaining participating machines have a gain from participation in the job.

In this way, the production quantity (%) of the participating machines for the corresponding order are determined.

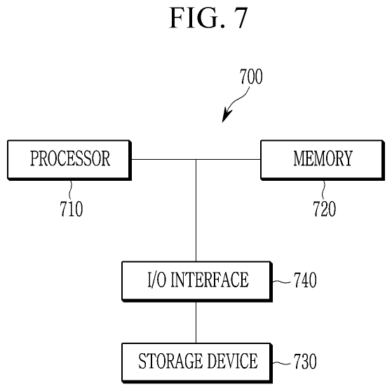

FIG. 7 is a diagram schematically illustrating an apparatus for distributed collaborative resource allocation according to an exemplary embodiment of the present invention.

Referring to FIG. 7, the apparatus for distributed collaborative resource allocation 700 includes a processor 710, a memory 720, a storage device 730, and an input/output (I/O) interface 740. The apparatus for distributed collaborative resource allocation 700 may be the factory agent itself, and may be implemented in the factory agent. The apparatus for distributed collaborative resource allocation 700 may be the machine agent itself, or may be implemented in the machine agent.

The processor 710 may be implemented as a central processing unit (CPU) or other chipset, a microprocessor, etc.

The memory 720 may be implemented as a medium such as random access memory (RAM), such as dynamic random access memory (DRAM), rambus DRAM (RDRAM), synchronous DRAM (SDRAM), static RAM (SRAM), etc.

The storage device 730 may be implemented as a hard disk, optical disks such as a compact disk read only memory (CD-ROM), a CD rewritable (CD-RW), a digital video disk ROM (DVD-ROM), a DVD-RAM, a DVD-RW disk, Blu-ray disks, etc., a flash memory, or permanent or volatile storage devices such as various types of RAM.

The I/O interface 740 allows the processor 710 and/or the memory 720 to access the storage 730. In addition, the I/O interface 740 may provide an interface with the outside.

The processor 710 may perform the function of the factory agent or the machine agent described in FIGS. 1 to 6. The processor 710 may load a program command for implementing the function of the factory agent or the machine agent in the memory 720, and may control to perform the operation described with reference to FIGS. 1 to 6. These program commands may be stored in the storage device 730, or may be stored in other system connected through a network.

According to an embodiment of the present invention, it can be used to increase the competitiveness of the manufacturing industry through securing product flexibility, volume scalability, and manufacturing robustness in a manufacturing environment. In addition, productivity may be improved by responding through rapidly and autonomously resource allocation in the work site of the manufacturing factory, and in case of high variability in the manufacturing site, it is possible to allocate and utilize more robust resources than resource allocation through planning ahead.

Furthermore, it is possible to flexibly and quickly respond to various types of volatility, such as frequent changes of product models and specifications, such as quantity batch production and production of personalized products, and a machine problem or unexpected abnormal situations in various sites, and the cost and time burden of planning, managing, and controlling everything in a center may be reduced through the distributed collaboration among machines.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (08) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A method for distributed collaborative resource allocation for allocating machine resources through distributed collaboration among machines, the method comprising:
receiving, by each machine agent for each process, order information and job start information for each process from a factory agent;
calculating, for each machine agent for each process, slack time of a job used as an evaluation indicator for an order through the order information and job start information for each process;
determining, for each machine agent for each process, participation for the order using the evaluation indicator;
setting a machine agent having the highest evaluation indicator among machine agents for each process representing the participation as a negotiating agent for a corresponding process; and
proceeding with, by the negotiating agent of the corresponding process, negotiation for production quantity with the remaining machine agents representing the participation in the corresponding process.

2. The method of claim 1, wherein the proceeding with the negotiation includes performing the negotiation for production quantity in a way in which all machine agents representing participation in the corresponding process have a gain from participation in the job.

3. The method of claim 1, wherein the proceeding with the negotiation includes:
setting a production quantity of the negotiating agent as a first ratio and checking whether a gain from the participation of the negotiating agent in the job occurs;
when the gain from the participation of the negotiating agent occurs, setting a production quantity of the remaining machine agents representing the participation as a second ratio based on the first ratio and checking whether the gain from the participation of the remaining machine agents in the job occurs; and
adjusting the first ratio and the second ratio when not all of the remaining machine agents have a gain from participation in the job.

4. The method of claim 3, wherein the second ratio is determined based on the first ratio and the number of remaining machine agents.

5. The method of claim 3, wherein the adjusting of the first ratio and the second ratio includes reducing the first ratio by a set negotiation unit.

6. The method of claim 3, wherein the proceeding with the negotiation further includes setting the production quantity of the machine agents representing participation equally when there is no gain in the participation of the negotiating agent.

7. The method of claim 1, wherein the determining of participation for the order includes:
setting, for each machine agent, a desired threshold value for a job of a machine; and
determining, for each machine agent, participation for the order through a comparison between the evaluation indicator of each machine agent and the desired threshold value for the job of the machine of each machine agent.

8. The method of claim 7, wherein the desired threshold value for the job of the machine is set to be lower as a capacity utilization rate of the corresponding machine is lower.

9. The method of claim 1, wherein the calculating of a slack time of the job, the determining of participation for the order, the setting of a negotiating agent, and the proceeding with negotiation for production quantity are performed sequentially for each process.

10. The method of claim 9, wherein when the production quantity is determined through the negotiation in the previous process, job start information of the next process is determined by the factory agent.

11. An apparatus for distributed collaborative resource allocation for allocating machine resources through distributed collaboration among machines, the apparatus comprising:
an interface that sequentially receives process order information and job start information from a factory agent; and
a processor that calculates an evaluation indicator for the order in a corresponding process based on the process order information and job start information in the corresponding process, and determines participation of machine agents in the order using the evaluation indicator in the corresponding process, and determines production quantity through negotiation among machine agents representing the participation.

12. The apparatus of claim 11, wherein the processor compares the evaluation indicators of machine agents representing the participation, and allows a machine agent with a highest evaluation indicator to act as a negotiating agent.

13. The apparatus of claim 12, wherein when the processor acts as the negotiating agent, the processor performs negotiations on the production quantity in a way in which all machine agents representing participation in the corresponding process have a gain from participation in the job.

14. The apparatus of claim 12, wherein when the processor acts as the negotiating agent, the processor sets a production quantity of the negotiating agent as a first ratio and checks whether the gain from the participation of the negotiating agent in the job occurs, sets a production quantity of the remaining machine agents representing the participation as a second ratio and checks whether the gain from the participation of the remaining machine agents in the job occurs when the gain from the participation of the negotiating agent occurs, and adjusts the first ratio and the second ratio when not all of the remaining machine agents have the gain from participation in the job.

15. The apparatus of claim 14, wherein the second ratio is determined based on the first ratio and the number of remaining machine agents.

16. The apparatus of claim 14, wherein the processor sets the production quantity of the machine agents representing participation equally when there is no gain in the participation of the negotiating agent.

17. The apparatus of claim 11, wherein the processor sets a desired threshold value for a job of a machine, and determines that there is participation in the order when the evaluation indicator is equal to or higher than the desired threshold value for a job of a machine.

18. The apparatus of claim 11, wherein the evaluation indicator includes a slack time of the job.
